(19) United States
(12) Patent Application Publication
(10) Pub. No.: US 2005/0166757 A1
(43) Pub. Date: Aug. 4, 2005

(54) Supplemental filter for use in internal combustion engine

(75) Inventors: Mark T. Brandl, Viroqua, WI (US); Steven A. Kensok, Viroqua, WI (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(73) Assignee: S & S Cycle, Incorporated

(21) Appl. No.: 10/771,642

(22) Filed: Feb. 4, 2004

(51) Int. Cl. B01D 46/00

(52) U.S. Cl. 95/287; 55/482; 55/512; 96/90

(57) ABSTRACT

A supplemental filter for use in combination with a conventional annular air filter of an internal combustion engine. The supplemental filter in accordance with the present invention is for use in trapping hydrocarbon emissions. The supplemental filter includes a flexible cover which snugly envelops the conventional annular filter. Further, the supplemental filter includes means to effect sealing the flexible cover against opposite axial ends of the conventional filter. The supplemental filter further includes means, carried by the flexible cover, for distributing carbon media over a significant portion of the flexible cover.

### TECHNICAL FIELD

The present invention deals broadly with the field of vehicles and, more specifically, filters through which hydrocarbon vapors rising from a fuel reservoir in a carburetor of an internal combustion engine pass. Even more specifically, the invention deals with a supplemental filter which is able to be retrofitted to installed existing filtration devices to enable compliance with governmentally-imposed emission restrictions.

### BACKGROUND OF THE INVENTION

The genesis of vehicles powered by internal combustion engines dates back more than 100 years. When such vehicles were first developed, ecological concerns were not as apparent as they have become as we have proceeded into the twenty-first century. Internal combustion engine-powered vehicles, when first developed, generated concerns about virtually only functioning of the vehicle. Even fuel efficiency was not a major concern.

As time has progressed, however, issues not originally relevant have become significant. As the cost of automobiles, trucks and motorcycles has escalated, costs of operation have also increased commensurately. As a result, fuel efficiency issues have become of greater concern.

While fuel economy issues and other issues of this type are of personal concern, as the number of vehicles on the roadways of the world has increased, societal concerns have also burgeoned. One of these concerns to the public generally is the release of hydrocarbon emissions into the atmosphere. The deleterious effect of release of these emissions is well documented.

In response to the awareness of such releases and the perception of the need for greater control, the various states of the United States of America have proceeded to develop regulatory standards to control the emissions. The state of California, to date, has approved emission standards and test procedures for model motor vehicles of model year 2001 and subsequent thereto. All the other states have taken steps toward adopting similar emission standards and test procedures.

The California emission standards have been approved both for vehicles other than motorcycles and for motorcycles. The standards imposed in California are quite stringent.

In order to control and trap hydrocarbon emissions and limit them, existing designs have required the use of a special filter utilizing a media with a carbon layer mounted within the annular air filter structure in a rigid manner. One proffered solution is illustrated in U.S. Pat. No. 3,747,303 issued to inventor Robert K. Jordan on Jul. 24, 1973. The structure of that patent is entitled AIR-FILTER AND CARBON-BED ELEMENT FOR AN AIR CLEANER ASSEMBLY. The structure employs a ring of activated carbon particles for adsorbing and desorbing hydrocarbon vapors rising from a fuel reservoir in a carburetor of an internal combustion engine. The ring has a portion elevated above a base portion. Both portions extend between an air inlet side and an air outlet side and between top and bottom surfaces for securing and sealing the ring across the air path through an air cleaner. The elevated portion has passages that conduct air for the normal operation of the engine from the air inlet side of the ring to the air outlet side. Hydrocarbon vapors adjacent the outlet side from the carburetor are adsorbed by the carbon in the base and elevated portions before rising to the level of the passages.

As discussed above, the structure of the Jordan patent is one proffered solution. It certainly serves to resolve issues with respect to new-construction vehicles.

A problem remains, however, with respect to reconfiguring vehicles which have been on the road for a number of years and do not include apparatus enabling compliance with enacted and/or proposed regulatory schemes. Consequently, a significant problem exists with respect to vehicles not constructed in accordance with regulatory requirements.

It is to these shortcomings, deficiencies and problems of the prior art that the present invention is directed. It is a supplemental air filter which serves to overcome the shortcomings and deficiencies and solve the problems of the prior art.

### SUMMARY OF THE INVENTION

The present invention is a supplemental air filter which serves to trap hydrocarbon emissions emanating from an internal combustion engine. The supplemental air filter is intended for use with a conventional annular air filter of a type currently put in place by vehicle manufacturers. Such conventional air filters are, as indicated above, generally annular in shape and have opposite axial ends. Such a conventional air filter includes a generally annular filtration portion and a generally circular ring at each of opposite axial ends of the generally annular filtration portion. The supplemental air filter includes a flexible cover sized to fit snugly over the conventional filter. The supplemental air filter further includes means for sealing the cover against the generally circular rings at the axial ends of the annular filtration portion. Finally, the supplemental air filter includes means carried by the cover for distributing carbon media over a significant portion of the cover.

In one embodiment of the invention, the cover is generally annular in shape and has opposite axial ends which are able to be positioned overlying opposite axial ends of the conventional annular filter. The sealing means, in this embodiment, can take the form of rings of elastic material. When in position relative to the conventional annular air filter, a supplemental filter will be disposed such that the rings of elastic material exert radially inward force against the corresponding circular rings at each of opposite axial ends of the generally annular filtration portion of the conventional annular filter.

In a preferred embodiment, the means for distributing carbon media over a significant portion of the flexible cover can take the form of one or more fibrous matrix segments impregnated with activated carbon. Each fibrous matrix can, in turn, be inserted into a pocket defined by the cover. Such pockets can be formed by making the cover of a plurality of laminae. The laminae can be stitched together along borders to define the various pockets.

It will be understood that a fibrous matrix segment in each pocket is envisioned as being employed in the preferred embodiment. Various carbon media constructions can, however, be utilized.

The present invention is thus a supplemental air filter which serves to solve problems and address the shortcomings and deficiencies of the prior art. Further features and advantages obtained in view of those features will become apparent with reference to the DETAILED DESCRIPTION OF THE INVENTION, appended claims and accompanying drawing figures.

### BRIEF DESCRIPTION OF THE DRAWINGS

FIG. 1 is an exploded view illustrating a supplemental filter in accordance with the present invention in combination with a conventional annular filter;

FIG. 2 is a view similar to FIG. 1 with the supplemental filter received in place over the conventional annular filter;

FIG. 3 is a sectional view taken generally along the line 3-3 of FIG. 2;

FIG. 4 is a view illustrating a segment of fibrous matrix impregnated with activated carbon serving as the carbon media; and

FIG. 5 is a view illustrating a multiplicity of activated carbon pellets serving as the carbon media.

### DETAILED DESCRIPTION OF THE INVENTION

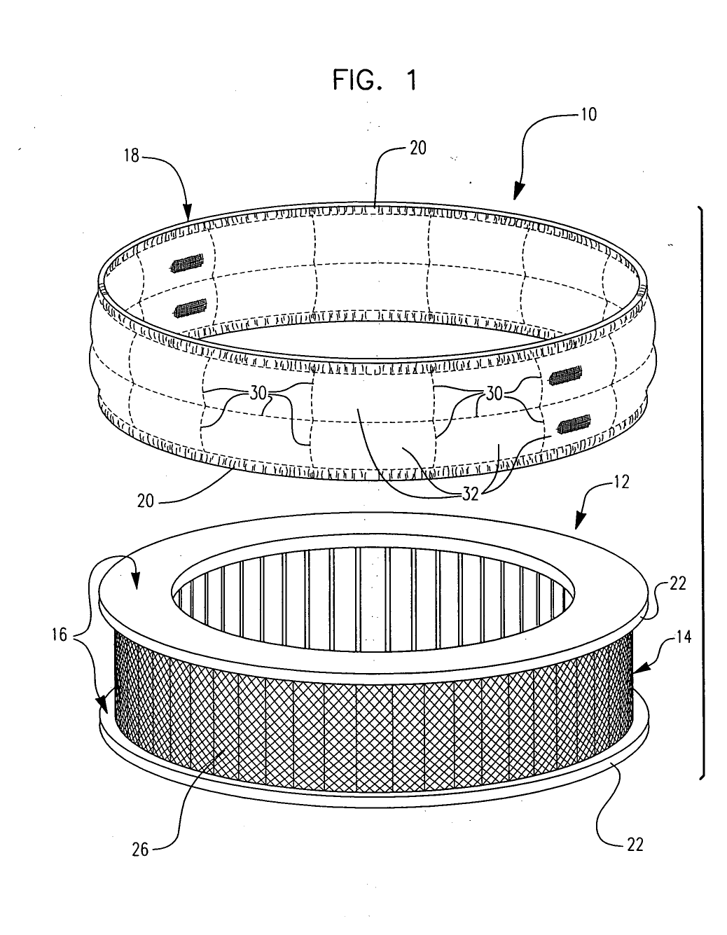

Referring now to the drawings wherein like reference numerals denote like elements throughout the several views, FIG. 1 illustrates a supplemental air filter 10 in accordance with the present invention. The supplemental air filter 10 serves to trap hydrocarbon emissions which might escape through a conventional annular air filter 12 of an internal combustion engine (not shown). Such a conventional annular air filter 12 typically includes a generally annular filtration portion 14 and a generally circular or hoop-like ring 16 at each of opposite axial ends of the filtration portion.

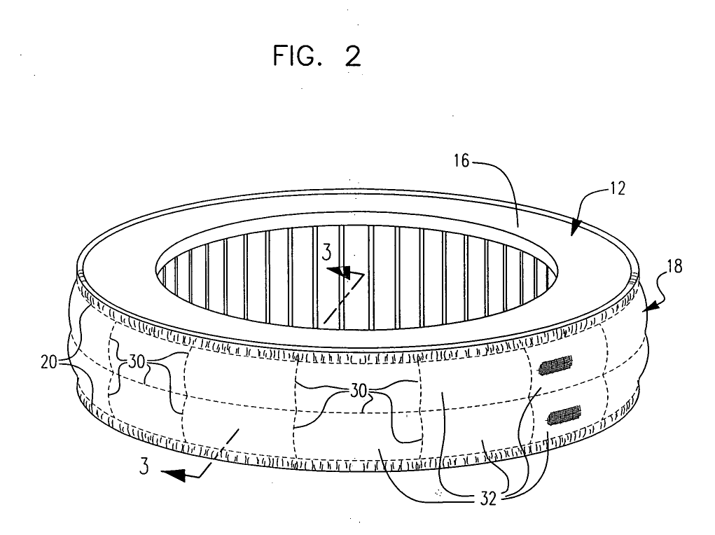

The supplemental filter includes a porous cover 18 which, as better seen in FIG. 2, can be positioned to closely overlie the generally annular filtration portion 14 of the annular filter 12. The supplemental filter 10 includes structure for sealing the cover 18 against the generally circular rings or hoops 16 of the annular filter 12 (again, as best seen in FIG. 2). The sealing structure can take the form of an elastic ring 20 at each of opposite axial ends of the cover 18. The cover 18 is shaped and sized so that, when it is fitted over the conventional annular air filter 12, each elastic ring 20 bears radially inwardly against, and in engagement with, a corresponding radially outwardly facing edge 22 of a corresponding circular ring or hoop 16 of the filter 12.

As seen in FIG. 1, the outer diameter of each ring or hoop 16, while generally equal to that of the other ring or hoop, is greater than the outside diameter of the annular filtration portion 14 of the conventional annular filter 12. When the cover 18 is positioned in place with the elastic rings 20 in engagement with corresponding rings or hoops 16 of the filter 12, a substantially annular plenum 24 will be defined between the outer surface 26 of the annular filtration portion of the filter and the cover structure 18.

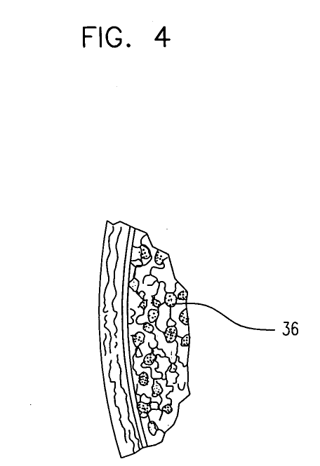

In the preferred embodiment of the invention, the cover 18 comprises multiple laminae 28 of overlapping flexible material. The laminae 28 are secured together (for example, by stitching 30 along boundaries) to define a plurality of pockets 32. Each pocket 32, in turn, has an activated carbon media material 34 inserted therewithin. In the preferred embodiment, such activated carbon media 34 takes the form of a segment of fibrous matrix 36 impregnated with activated carbon. FIG. 4 illustrates such a fibrous matrix segment 36.

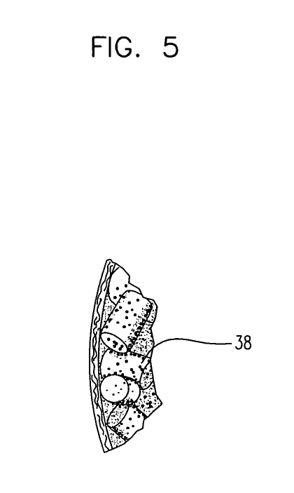

It will be understood that other activated carbon media forms can also serve the function of trapping hydrocarbon emissions. FIG. 5 illustrates a multiplicity of activated carbon pellets 38 received in each pocket 32.

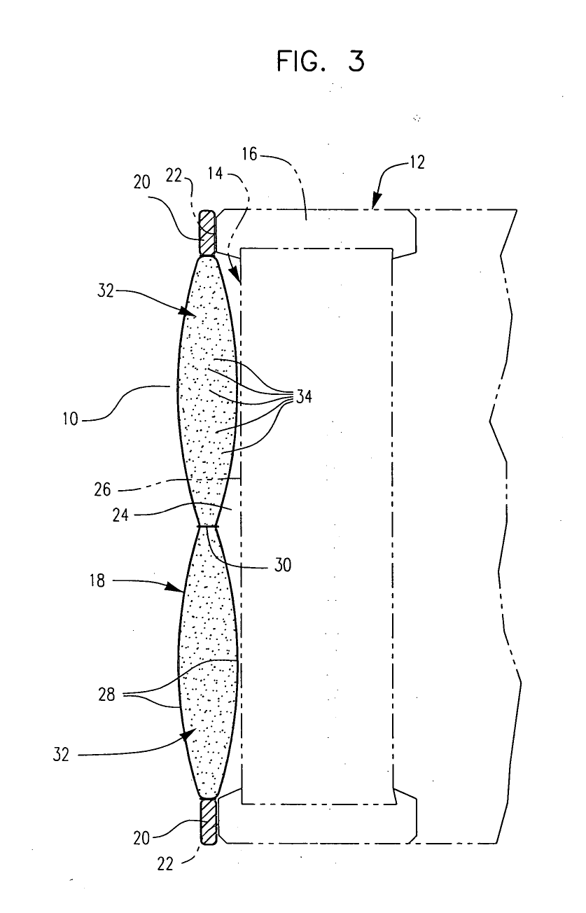

FIGS. 1-3 illustrate two axially spaced loops of pockets 32 in which an activated charcoal medium 34 is contained. It will be understood, however, that such a number of pockets 32 is merely illustrative, and the actual number of pockets and loops of pockets can vary depending upon circumstances.

It will be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

1. A supplemental air filter for trapping hydrocarbon emissions, for use with a conventional annular air filter of an internal combustion engine, the supplemental air filter comprising:
a flexible cover sized to snugly envelop the conventional annular filter;
means for sealing said flexible cover against opposite axial ends of the conventional annular filter; and
means carried by said flexible cover for distributing carbon media over a significant portion of said flexible cover.

2. A supplemental air filter in accordance with claim 1 wherein said flexible cover is generally annular in shape, opposite axial ends of said cover being positionable over opposite axial ends of the conventional annular filter.

3. A supplemental air filter in accordance with claim 2 wherein said means for sealing comprises elastic rings at said opposite axial ends of said cover, said elastic rings exerting radially inward force against the opposite axial ends of the conventional annular filter.

4. A supplemental air filter in accordance with claim 1 wherein said means for distributing comprises at least one fibrous matrix impregnated with activated carbon.

5. A supplemental air filter in accordance with claim 4 wherein said means for distributing comprises a plurality of fibrous matrix segments impregnated with activated carbon, each of said plurality of fibrous matrix segments received within a corresponding one of a plurality of pockets defined by said flexible cover.

6. A supplemental air filter in accordance with claim 1 wherein said means for distributing comprises a plurality of pockets defined by stitching together, at defined locations, a plurality of laminae comprising said flexible cover.

7. A supplemental air filter in accordance with claim 6 wherein each of said pockets encloses a multiplicity of activated carbon pellets.

8. An air cleaner assembly, comprising:
an annular air filter as conventionally used in a carburetor of an internal combustion engine, the annular air filter including a generally annular filtration portion and a generally circular ring at each of opposite axial ends of the generally annular filtration portion;
a cover positionable to closely overlie the generally annular filtration portion of the annular filter;
means for sealing said cover against the generally circular rings of the annular filter;
laminae of overlapping flexible material comprising said cover, said laminae secured together along boundaries to define a plurality of pockets; and
carbon media carried within said pockets.

9. An air filter assembly in accordance with claim 8 wherein said sealing means comprises an elastic ring radially inwardly engagable against each of said generally circular rings at the opposite axial ends of the generally annular filtration portion of the annular air filter.

10. An air cleaner assembly in accordance with claim 8 wherein said carbon media carried within said pockets comprises a segment of fibrous matrix impregnated with activated carbon and received within one of said pockets.

11. A method for retrofitting a conventional annular air filter of an internal combustion engine for trapping hydrocarbon emissions, wherein the conventional air filter is annular, comprising the steps of:
providing a cover positionable over the conventional annular filter in relatively tight engagement with an outer surface of the conventional annular filter;
sealing the cover against opposite axial ends of the conventional annular air filter; and
distributing activated carbon media over an area of an outwardly facing surface of the conventional annular filter.
